(19) United States
(12) Patent Application Publication
(10) Pub. No.: US 2008/0228801 A1
(43) Pub. Date: Sep. 18, 2008

(54) CONTEXT-VARIABLE DATA FRAMEWORK FOR HIERARCHICAL DATA WAREHOUSING

(75) Inventors: Dale Edward McFarlane, Houston, TX (US); Billy Todd Harris, Houston, TX (US); Stanley Leon Moore, Houston, TX (US); Frederick Ernest Barns, Broaddus, TX (US); Randall Lee Sanders, Houston, TX (US)

Correspondence Address: CONLEY ROSE, P.C.;David A. Rose, P. O. BOX 3267, HOUSTON, TX, 77253-3267, US

(73) Assignee: CHAMPION TECHNOLOGIES, INC., Houston, TX (US)

(21) Appl. No.: 11/685,298

(22) Filed: Mar. 13, 2007

(51) Int. Cl. G06F 17/00

(52) U.S. Cl. 707/102; 707/E17.005

(57) ABSTRACT

A method and system are provided for hierarchical data warehousing in a context-variable data framework. The method includes building a context-variable data framework. The context-variable data framework comprises 1) a data point of interest 2) one or more contextual hierarchies based on a type for the data point of interest, and 3) an organizational hierarchy. The method further includes populating the context-variable data framework with information relating to the data point of interest. The method also includes storing the context-variable data framework and the information in a centrally accessible data store.

### BACKGROUND

In most business enterprises, routine activities of the enterprise can result in vast amounts of data. A field referred to as data warehousing has developed for handling such quantities of data. Enterprises are driven to make more efficient use of their data through organization, navigability, and ease of reporting. Many innovations have made it possible to query vast quantities of data in data warehouses, but fail to meet the needs of all business decision makers.

For example, in the oil and gas field, voluminous amounts of data are generated relating to production, maintenance, inventory, and other oil and gas areas of business. For a service company as one illustrative business enterprise, there is a need to organize and manage the data for each of its customers. For a producer as still another illustrative business enterprise, there is a need to organize and manage the data generated internally and incorporate data generated by service companies with whom it works as well as data generated by subsidiaries and the like.

### SUMMARY

In accordance with embodiments of the present disclosure, a method is provided. The method includes building a context-variable data framework. The context-variable data framework comprises 1) a data point of interest, 2) one or more contextual hierarchies based on a type for the data point of interest, and 3) an organizational hierarchy. The method further includes populating the context-variable data framework with information relating to the data point of interest. The method also includes storing the context-variable data framework and the information in a centrally accessible data store.

In alternative embodiments of the present disclosure, yet another method is provided for building a context-variable data framework. The method includes adding a data point of interest for an enterprise to a context-variable data framework in a user interface. The method also includes associating an organizational hierarchy for the enterprise with the data point of interest in the context-variable data framework. The method additionally includes associating one or more contextual hierarchies with the data point of interest in the context-variable data framework based on a type for the data point of interest. The method further includes storing the context-variable data framework to a data store accessible through the user interface.

In still further embodiments of the present disclosure, a system is provided. The system includes an input/out interface operable to receive a plurality of inputs including a data point of interest and a type for the data point of interest. The system also includes a framework module that provides a context-variable data framework, wherein the context-variable data framework comprises the data point of interest associated with an organizational hierarchy and one or more contextual hierarchies based on the type for the data point of interest. Further, the system includes a data warehouse accessible through the input/output interface operable to store the context-variable data framework.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a block diagram of a web-interfaced software module in accordance with embodiments of the present disclosure.

FIG. 2 is a block diagram of a network architecture in which the software module of FIG. 4 functions, in accordance with embodiments of the present disclosure.

FIG. 3 is a flowchart of a method for building and using the context-variable data framework in the system of FIG. 1 in a network architecture such as that of FIG. 2.

FIG. 4 is a flowchart of a process for generating data in accordance with one illustrative embodiment of the present disclosure.

FIG. 5 is a diagram of various sample, measure, and injection and inventory points for generating data in accordance with one illustrative embodiment of the present disclosure.

FIG. 6 is a diagram of a hierarchy for organizing, storing, and navigating data in accordance with one illustrative embodiment of the present disclosure.

FIG. 7 illustrates an exemplary general purpose computer system suitable for implementing embodiments of the present disclosure.

### DETAILED DESCRIPTION

It should be understood at the outset that although an illustrative implementation of one embodiment of the present disclosure is illustrated below, the present system may be implemented using any number of techniques, whether currently known or in existence. The present disclosure should in no way be limited to the illustrative implementations, drawings, and techniques illustrated below, including the exemplary design and implementation illustrated and described herein, but may be modified within the scope of the appended claims along with their full scope of equivalents.

The quantities of data described above may be more easily navigated, organized, and used for reporting in a context-variable data framework, thereby enabling and improving business decisions based on the data. Specifically, a context-variable data framework may be constructed in a hierarchical format based on the type of the data that will be organized and stored therein. Additionally, the context-variable data framework may include in the hierarchical format layers that pertain to the business enterprise using the data organized and stored therein, such that the data is navigable according to the enterprise's internal constructs as well. The context-variable data framework and methods of the present disclosure enable streamlining the entry, storage, and reporting of data points of interest, such that data is formatted for use, and navigated according to common structures throughout the business enterprise. Storing the data in the context-variable data framework that is easily navigable and centrally accessible in a web-interfaced system and architecture ensures that data is available when needed, and access to proprietary data may be easily electronically controlled.

For example, in an enterprise in the oil and gas industry, the data of interest may be of a type that contextually indicates that at least two hierarchies be employed in the context-variable data framework. Specifically, given the nature of the oil and gas industry, a sample data point may be taken, and the sample data type in the system of the present disclosure precipitates the need for at least an organizational hierarchy (as the oil and gas enterprise may include a corporation and any number of subsidiaries business units, and divisions), as well as a context-based hierarchy of geography (as a single sample may pertain to any number of different geographic units such as a field, a platform or lease, a location, a unit, and an individual well.)

In another example, in an enterprise in the manufacturing industry, the data point of interest may be of a type that contextually indicates that at least three hierarchies be employed in the context-variable data framework. Specifically, given the nature of the manufacturing industry, a single data point in the factory may represent materials, and the data type in the system of the present disclosure precipitates the need for at least an organizational hierarchy (as the manufacturing enterprise may include a corporation and any number of subsidiaries, business units, divisions, and design projects), as well as two context-based hierarchies, such as inventory (as a single data point representing materials may consist of an asset that is raw material, a work-in-progress, or finished product, etc.) and accounting (as a single data point representing materials may relate to both accounts receivable and accounts payable).

In still another example, in an enterprise in the project management context, the data point of interest may be of a type that contextually indicates that a plurality of hierarchies be employed in the context-variable data framework. Specifically, given the nature of project management, a single data point of a task may be entered in the system, and the data type in the present disclosure precipitates the need for at least an organizational hierarchy (as the enterprise on whose behalf the task is performed may include a corporation and any number of subsidiaries, business units, divisions, and design projects), as well as a plurality of context-based hierarchies, such as project (as a single task may objectively contribute towards completion of one or more projects), personnel (as completion of a single task may involve the cooperation of a number of employees, teams, or contractors), cost (as completion of the task may involve one or more budgets) and timeline (as a single task data point may pertain an overall enterprise timeline, as well as a timeline for each organizational level or project).

Thus, the use of the context-variable data framework of the present disclosure enables storing and navigating data in a framework that is customized to best suit the type of the data. The present disclosure provides further detail with regard to embodiments illustrative of the context-variable data framework.

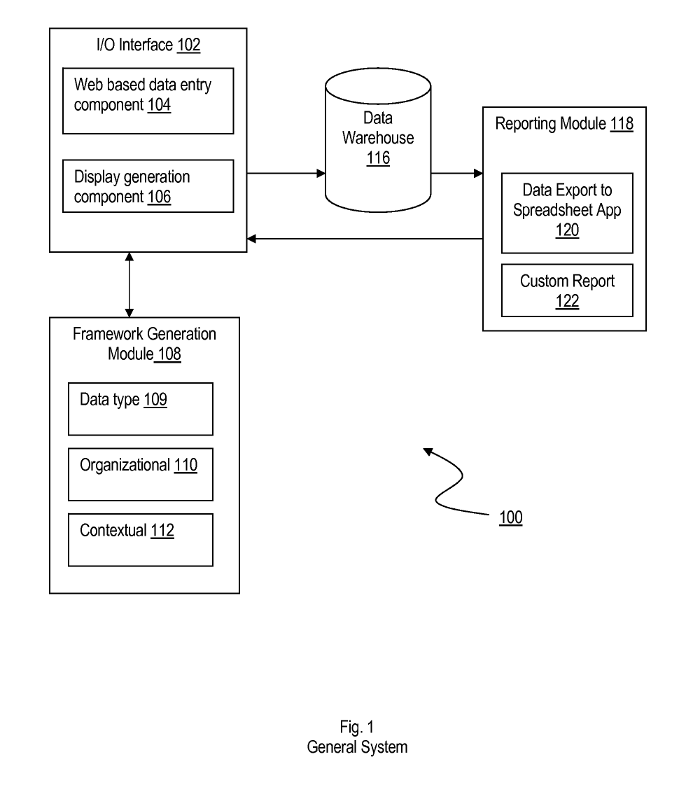

FIG. 1 is a block diagram of a web-interfaced software module 100 implementing the context-variable data framework. The software module 100 includes an input/output interface 102 having a user data entry component 104 and a display generation component 106. The input/output interface 102 receives inputs from a user for building and populating the context-variable data framework. The display generation component 106 generates screen views for displaying reports, populated context-variable data frameworks, and the like.

A structured set of data entry components (such as fill-in text boxes, drop down menus, buttons, and the like) may be used to guide the user into providing a uniform set of information for each entry at each of the context-variable data framework levels, thereby ensuring that data stored and viewed in the software module is universally formatted and may be used across the enterprise for various functions. Likewise, the structured set of data entry components ensures that users provide like inputs, in like units, rather than each user recording data in his own fashion.

A framework generation module 108 is also coupled to the input/output interface 102. The framework generation module 108 examines the data type (provided by the user, either directly, as an indirect result of the user providing the data point of interest) for any given data point of interest input to the system. The framework generation module 108 compares the data type to a table of stored data types 109. Based on the type for the data point of interest, the framework generation module 108 associates the appropriate hierarchies with the data point of interest in a context-variable data framework, and provides the framework to the input/output interface 102. Once the context-variable framework is generated, the framework may be further populated with information that relates to the data point of interest. Once populated, the context-variable data framework is stored in a data warehouse 116. Once information is stored in the data warehouse 116, the information may be supplemented or modified at any time through the input/output interface 102 by navigating through the context-variable data framework to the desired information, making changes or additions, and saving to the data warehouse 116 again.

The framework generation module 108 includes the data type table 109, as well as organizational hierarchies store 110 and contextual hierarchies store 112. The framework generation module 108 compares the type provided to types in the data type table 109 to determine which (and how many) hierarchies to associate with the particular data point of interest. From the organizational hierarchies store 110 and the contextual hierarchies store 112, the framework generation module 108 provides the one or more hierarchies that comprise the context-variable data framework. In some embodiments, the framework generation module 108 selects and provides only an organizational hierarchy and one contextual hierarchy, though in other embodiments, any number of organizational hierarchies and contextual hierarchies may pertain to the input data point of interest and thus are appropriate for inclusion in the context-variable data framework. The framework generation module 108 may be populated (as well as later updated or modified) to include any and all potentially relevant organizational and contextual hierarchies that may relate to the types of data to be input to the system.

The software module further includes a reporting module 118 coupled to the data warehouse 116 that is operable to extract data from the data warehouse 116 to generate a data export to an external spreadsheet application 120, such as Microsoft Excel™, or to generate a customized report within the software module in a custom report module 122 that is displayed in the display 106 of the input/output interface 102. A custom report could include, for example, routine reporting on aspects of a data point of interest. In the oil and gas industry example above, the data point of interest SMI may form the basis for routine reporting on aspects such as water, iron, residuals, chlorides, deposits, wax, corrate, and the like. A custom report could also include, for example, product research and development information or product selection tests, which includes as emulsion, foaming, wheel test, RCE, cloud point, pour point, or the like for the oil and gas industry example. Additionally, a custom report could also include, for example, inventory or consumption for a material or product in the manufacturing example described above. Financial reports may also be generated, either in custom reports or in a data export to a spreadsheet application, including for example benchmarking reports, return on investment reports, and the like.

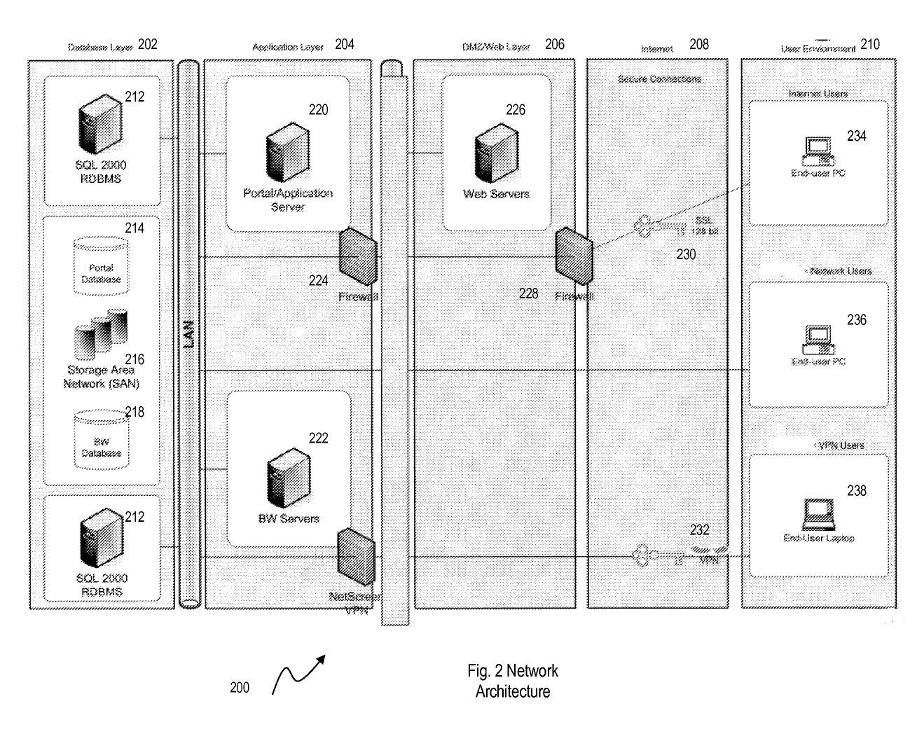

FIG. 2 is a block diagram of a network architecture 200 in which the software module of FIG. 1 may function in various embodiments. The network architecture 200 includes five layers: the database layer 202, the application layer 204, the web layer 206, the network layer 208, and the user environment layer 210. The database layer 202 includes the various data stores for implementing the data warehouse 116, namely one or more Structured Query Language (SQL) relational database management systems (RDBMS) 212 that store the information input to the software module 100 pertaining to a context-variable data framework, a portal database 214 that stores information pertaining to the software module 100 (such as for example log-in credentials for users, user preferences, etc.), a Storage Area Network 216 that is specifically dedicated to the task of transporting data for storage and retrieval, and a Business Warehouse 218 that stores, for example, the organizational and contextual hierarchies 110 and 112 as well as the data type table 109.

The application layer 204 includes a portal/application server 220 to which a user logs in to be able to access the information stored in the RDBMS 212, and one or more business warehouse servers 222 to which a user logs in to be able to access the information stored in the business warehouse database 218. Both the portal/application server 220 and the business warehouse servers 222 are located within a firewall 224 to protect the data stored in the database layer, as such data is proprietary in various environments.

The web layer 206 includes one or more web servers 226, also protected via firewall 228, that form the actual interface that users log on to in order to access the application layer 204 and database layer 202. The web layer 206 performs the interface functions, permitting users to add, manipulate, and view data. The network layer 208 forms the network connection by which the user may log on to the web layer 206 with proper log on credentials. The network layer 208 may include various secure connections, including for example, a 128 bit Secure Sockets Layer (SSL) connection 230, or a Virtual Private Network (VPN) connection 232.

The user environment 210 exists on the user's computer, which may be any general purpose computer. The user environment 210 may include Internet users 234, internal network (e.g., intranet) users 236, and internal network users operating outside the network 238 (e.g., “external” VPN users). This architecture offers access to the information from anywhere that one of the connections may be obtained, including on a wireless connection in the field or on a drilling platform, to business offices.

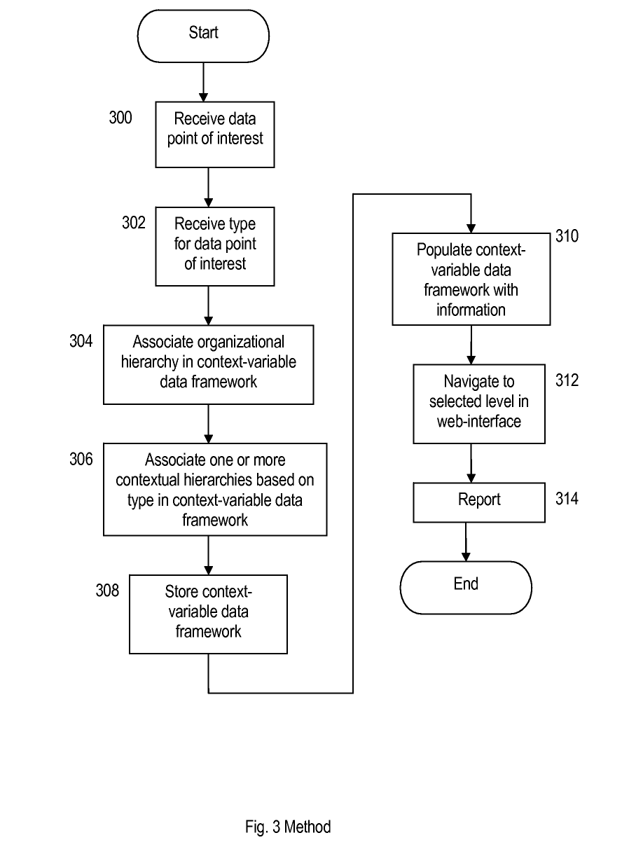

FIG. 3 is a flowchart of a method for building and using the context-variable data framework in the system of FIG. 1 in a network architecture such as that of FIG. 2. The method begins with receiving a data point of interest (block 300) and a type for the data point of interest (block 302). As before, the user may provide the type directly, or indirectly, as a result of providing to the software module 100 the data point of interest, from which the software module may derive the type.

The method continues with associating an organizational hierarchy with the data point of interest in a context-variable data framework, thereby building the framework (block 304). The organizational hierarchy associated with the data point of interest may include one or more levels according to the business structure of the enterprise that owns, controls, or is interested in the data point of interest. For example, an organizational hierarchy may include the levels of a corporation, the corporation's subsidiary companies, the corporation or subsidiary company business units, and/or divisions within the corporation, companies or business units. The organizational hierarchy may be predetermined and stored in the organizational hierarchy store 110 of the framework generation module 108. Alternatively, the user may define the organizational hierarchy at the outset for a particular enterprise. In some embodiments, the organizational hierarchy may include additional or fewer levels based on the identity of the user. For example, a contractor may be permitted access to fewer levels of the enterprise organization pertaining to his or her work, while an individual in upper management is permitted access to all levels of the enterprise organization.

The method continues with associating a one or more contextual hierarchies based on the type of the data point of interest, and adding the associated contextual hierarchies to the context-variable data framework, thereby further building the framework (block 306). The number of contextual hierarchies, as well as the actual content of levels in the hierarchies, associated with the data point of interest depends on the data point's type, from among the data type store 109. The various contextual hierarchies may be predetermined and stored in the contextual hierarchy store 112 of the framework generation module 108. Alternatively, the user may define a contextual hierarchy at the outset, particularly for a data type not previously used in the software module 100. In some embodiments, the one or more contextual hierarchies may include additional or fewer levels based on the identity of the user. For example, a customer may have restricted access to some types of data, while a decision maker for the enterprise, such as a manager or accountant, may have access to all types of data.

The context-variable data framework created from the associations of hierarchies with the data point of interest is then stored in a centralized data store (block 308) accessible through the software module 100 of a network architecture 200 such as that described with respect to FIG. 2.

With the context-variable data framework established, the method proceeds with populating the context-variable data framework with information (block 310). Populating the framework may be performed by presenting a template (which may be universal or customized per user) into which the user enters at least a minimum of required data in a format common to the enterprise. In various embodiments, the software module 100 may prevent the user from continuing until the entered information exceeds the minimum required entry, the data is properly formatted, or other requirements as set by the enterprise. For example, in the framework having an organizational hierarchy including a corporation, the software module 100 may require that the user enter an ID number, a status, a name, and contact information for a corporation in order to populate the corporation level in the context-variable data framework. The information populating the context-variable data framework is also stored in the centralized data store.

The method proceeds with navigating the context-variable data framework in the software module, for example, by expanding the context-variable data framework to reach the desired level and displaying the sought after information (block 312). For navigation purposes, the context-variable data framework may appear, for example, as an expanding tree format, such that selecting a relatively higher level on the context-variable data framework opens a branch to navigate the relatively lower levels. The method proceeds by further reporting on the sought after information (block 314). Reporting may include generating a data export to a spreadsheet application or generating a custom report within the software module, as described above.

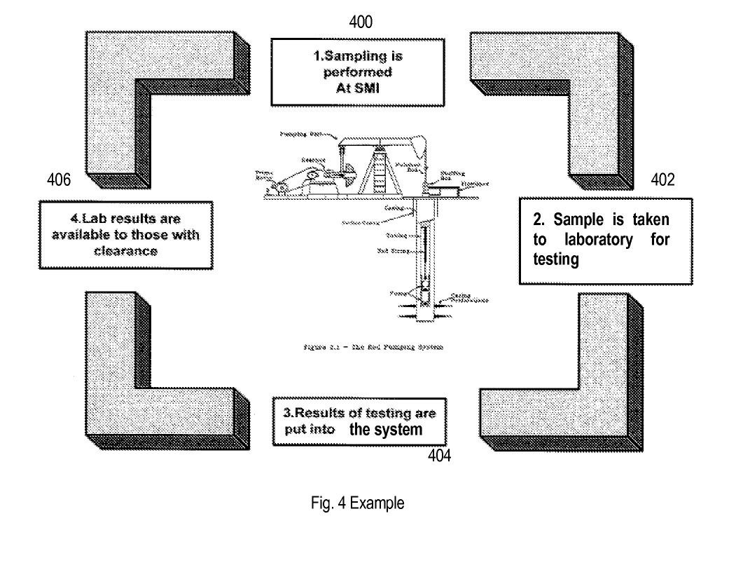

FIG. 4 is a flowchart of a process for generating one type of data for an enterprise in the oil and gas industry. As shown in FIG. 4, sampling is performed (block 100) at a sample, measurement, injection and inventory (“SMI”) point on a well that is located on a unit of a location lease or platform in a given field that is operated by a corporation (or some subsidiary of the corporation which will be discussed further below). In some embodiments, at block 400, a measurement or calculation may be performed and recorded. The sample or measurement, representative of a data type, is taken to a laboratory for testing or further calculations (block 402). The results from the laboratories further representing the data type, are stored as records (block 404), and the results are then available to those individuals having authority or clearance to review them (block 406). For example, a services company may perform such sampling or measurements for various different operators, and make results of each sample available only to the relevant operator for whom the service was performed.

Prior to the present disclosure, the data generated in sampling and measuring, and the results from laboratories, was recorded and organized differently by each individual doing the recording, and may not have been stored centrally in an accessible fashion. For example, a technician may record all of his samples in an Excel™ spreadsheet in a fashion useful for himself, and stored the Excel™ spreadsheet locally on his computer. Local copies, or even hard copies, of data that is not recorded in a universally used format makes it difficult to make use of the data. Additionally, work is duplicated as the results are not centrally accessible to reflect that various tasks have already been completed. Furthermore, the vast quantity of data that is generated by regular operations of such an enterprise calls for the navigable context-variable data framework of the present disclosure, based on the SMI type of data.

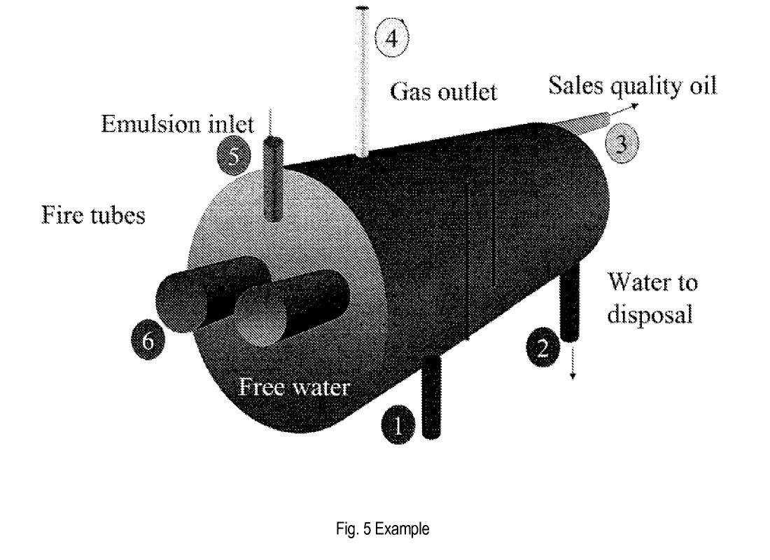

FIG. 5 is a diagram of various sample, measure, injection and inventory points on a treater unit for generating a particular data type of data points of interest in the context of the present disclosure. On a treater unit, there may be a plurality of SMI points including, for example, a (1) Treater Front Water Dump, (2) Treater Rear Water Dump, (3) Treater Clean Oil Dump, (4) Treater Gas Outlet, (5) Treater Emulsion Inlet, and (6) Treater Fire Tubes. At each SMI point (i.e., data point of interest) shown, a sample may be taken, a measurement may be made, or an injection may be made. Each such action results in information for documentation, such that information pertaining to the SMI is recorded and added into the context-variable data framework at the level for the particular SMI, over time resulting in a “big picture” view of all of the SMIs (i.e., data points of interest) under the control of, owned by, or of interest to an enterprise, throughout the context-variable data framework.

Each data point of interest in this example (i.e., SMI) is of the type “oil and gas process SMI,” which in the present system calls for the association of the data point of interest (i.e., the SMI) with various hierarchies. Specifically, the SMI data type is associated with at least an organizational hierarchy (i.e., for the enterprise that controls, owns, or is interested in the SMI) as well as a geographical hierarchy relating to the SMI. Values for samples, measurements, injections, and lab results for each SMI may then populate the framework, and other hierarchy levels (geographical and organizational) may be populated with accurate facts for that particular SMI.

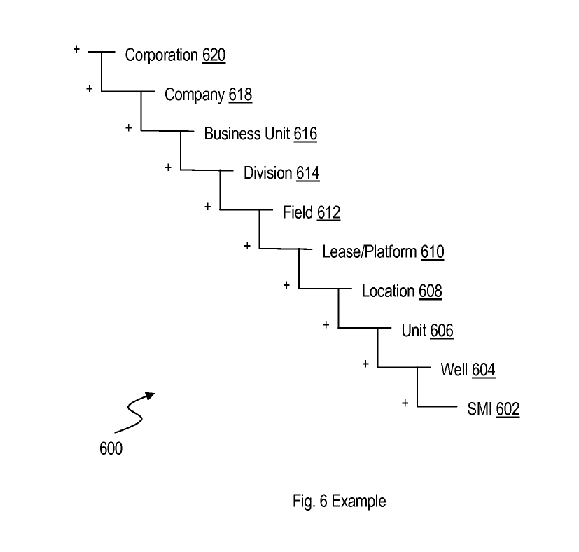

The association based on the SMI type generates a context-variable data framework (such as that shown in FIG. 6) in the software module 100. FIG. 6 is a diagram of a context-variable data framework for organizing, storing, and navigating information relating to SMI type data points of interest. Given the nature of the oil and gas industry, such a context-variable data framework may be universally used by and in support of operators of the largest size down to the small independent operator or the service company. As shown, the context-variable data framework includes the contextual hierarchy of geography comprising, from the bottom upward, an SMI data point 602, a Well 604 with which the SMI is associated, the Unit 606 in which the Well 604 is drilled, the Location 608 wherein the Unit 606 falls, the Lease or Platform 610 wherein the Location 608 is located, and the Field 612 in which the Lease or Platform 610 produces. As shown, the context-variable data framework includes the organizational hierarchy comprising, from the bottom upward, a division 614, a business unit 616, a company 618 and a corporation 620.

The manner in which the oil and gas industry works (both under regulatory agencies and in business) thus lends itself to using the hierarchy 200 for organization, storage, and simplified navigation of data.

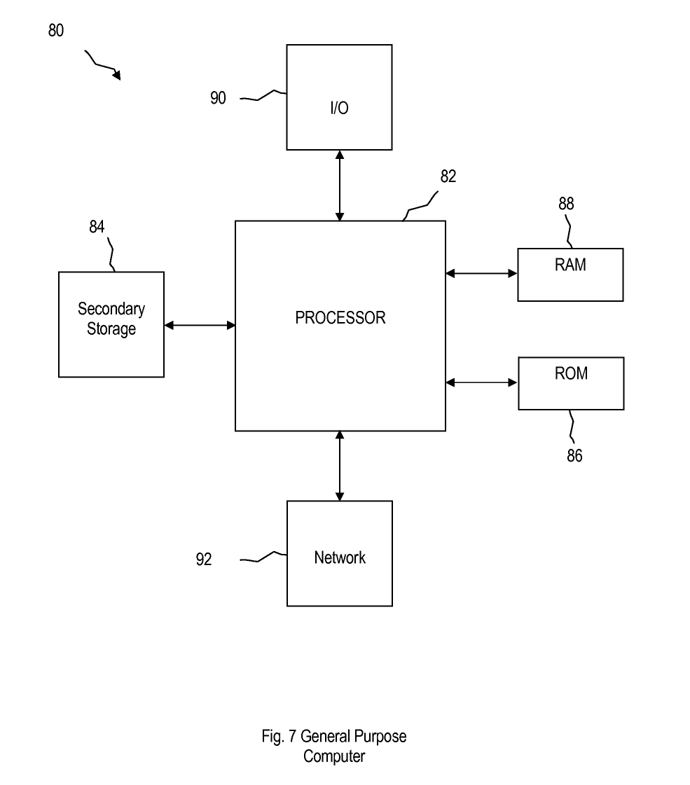

The system described above may be implemented on any general-purpose computer with sufficient processing power, memory resources, and network throughput capability to handle the necessary workload placed upon it. FIG. 7 illustrates a typical, general-purpose computer system suitable for implementing one or more embodiments disclosed herein. The computer system 80 includes a processor 82 (which may be referred to as a central processor unit or CPU) that is in communication with memory devices including secondary storage 84, read only memory (ROM) 86, random access memory (RAM) 88, input/output (I/O) 90 devices, and network connectivity devices 92. The processor may be implemented as one or more CPU chips.

The secondary storage 84 is typically comprised of one or more disk drives or tape drives and is used for non-volatile storage of data and as an over-flow data storage device if RAM 88 is not large enough to hold all working data. Secondary storage 84 may be used to store programs which are loaded into RAM 88 when such programs are selected for execution. The ROM 86 is used to store instructions and perhaps data which are read during program execution. ROM 86 is a non-volatile memory device which typically has a small memory capacity relative to the larger memory capacity of secondary storage. The RAM 88 is used to store volatile data and perhaps to store instructions. Access to both ROM 86 and RAM 88 is typically faster than to secondary storage 84.

I/O 90 devices may include printers, video monitors, liquid crystal displays (LCDs), touch screen displays, keyboards, keypads, switches, dials, mice, track balls, voice recognizers, card readers, paper tape readers, or other well-known input devices. The network connectivity devices 92 may take the form of modems, modem banks, ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices. These network connectivity 92 devices may enable the processor 82 to communicate with an Network or one or more intranets. With such a network connection, it is contemplated that the processor 82 might receive information from the network, or might output information to the network in the course of performing the above-described method steps. Such information, which is often represented as a sequence of instructions to be executed using processor 82, may be received from and outputted to the network, for example, in the form of a computer data signal embodied in a carrier wave

Such information, which may include data or instructions to be executed using processor 82 for example, may be received from and outputted to the network, for example, in the form of a computer data baseband signal or signal embodied in a carrier wave. The baseband signal or signal embodied in the carrier wave generated by the network connectivity 92 devices may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 82 executes instructions, codes, computer programs, scripts which it accesses from hard disk, floppy disk, optical disk (these various disk based systems may all be considered secondary storage 84), ROM 86, RAM 88, or the network connectivity devices 92.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. A method, comprising:
building a context-variable data framework, wherein the context-variable data framework comprises 1) a data point of interest, 2) one or more contextual hierarchies based on a type for the data point of interest, and 3) an organizational hierarchy;
populating the context-variable data framework with information relating to the data point of interest; and
storing the context-variable data framework and the information in a centrally accessible data store.

2. The method according to claim 1, further comprising navigating to a selected level in the context-variable data framework, and generating a report of information stored with respect to the selected level.

3. The method according to claim 1, wherein an organizational hierarchy comprises one or more of a corporation, a company, a business unit, and a division.

4. The method according to claim 1, wherein building the context-variable data framework further comprises receiving the data point of interest and the type for the data point of interest, and generating the context-variable data framework by combining the organizational hierarchy and one or more contextual hierarchies associated with the type.

5. The method according to claim 2, wherein navigating to the selected level further comprises expanding the context-variable data framework in a user interface until the selected level is accessible, and opening the selected level.

6. The method according to claim 2, wherein generating the report further comprises at least one of exporting the information for the selected level to a spreadsheet application and generating an analysis of the information for the selected level in a customized report.

7. The method according to claim 1, wherein each of the one or more contextual hierarchies is at least one of 1) a predetermined stored hierarchy and 2) a user defined hierarchy.

8. The method according to claim 1, further comprising displaying the context-variable data framework.

9. The method according to claim 8, wherein adjusting the display of the context-variable data framework based on at least one of the identity of a user and a user preference.

10. The method according to claim 1, wherein the data point of interest comprises an SMI point, and one contextual hierarchy for the SMI type of data point comprises a geographical hierarchy comprising one or more of a location level, a unit level, a lease level, a platform level, and a well level.

11. A method for building a context-variable data framework, comprising:
adding a data point of interest for an enterprise to a context-variable data framework in a user interface;
associating an organizational hierarchy for the enterprise with the data point of interest in the context-variable data framework;
based on a type for the data point of interest, associating one or more contextual hierarchies with the data point of interest in the context-variable data framework; and
storing the context-variable data framework to a data store accessible through the user interface.

12. The method according to claim 11, wherein associating an organizational hierarchy further comprises receiving a minimum amount of identifying data pertaining to the enterprise, and saving the minimum amount of identifying data to the organizational hierarchy in the context-variable data framework.

13. The method according to claim 11, further comprising navigating to a selected level in the context-variable data framework, and generating a report of information stored with respect to the selected level.

14. The method according to claim 11, wherein an organizational hierarchy comprises one or more of a corporation, a company, a business unit, and a division.

15. The method according to claim 13, wherein navigating to the selected level further comprises expanding the context-variable data framework in a user interface until the selected level is accessible, and opening the selected level.

16. The method according to claim 15, wherein display of any specific level in the context-variable data framework is limited based on the identity of a user.

17. The method according to claim 13, wherein generating the report further comprises at least one of exporting the information for the selected level to a spreadsheet application and generating an analysis of the information for the selected level in a customized report.

18. The method according to claim 11, wherein the data point of interest comprises an SMI point, and one contextual hierarchy for the SMI type of data point comprises a geographical hierarchy comprising one or more of a location level, a unit level, a lease level, a platform level, and a well level.

19. A network-based system, comprising:
an input/out interface operable to receive a plurality of inputs including a data point of interest and a type for the data point of interest;
a framework module that provides a context-variable data framework, wherein the context-variable data framework comprises the data point of interest associated with an organizational hierarchy and one or more contextual hierarchies based on the type for the data point of interest; and
a data warehouse accessible through the input/output interface operable to store the context-variable data framework.

20. The system according to claim 19, further comprising a reporting module operable to generate a report in at least one of a data export to a spreadsheet application and a customized report.

21. The system according to claim 19, wherein an organizational hierarchy comprises one or more of a corporation, a company, a business unit, and a division.

22. The system according to claim 19, wherein each of the one or more contextual hierarchies is at least one of 1) a predetermined stored hierarchy and 2) a user defined hierarchy.

23. The system according to claim 19, wherein the input/output interface is further operable to display the context-variable data framework.

24. The system according to claim 23, further comprising a data store of system user credentials and system user preferences, such that the input/output limits the display based on at least one of the identity of the user and the system user preferences.

25. The system according to claim 19, wherein the data point of interest comprises an SMI point, and one contextual hierarchy for the SMI type of data point comprises a geographical hierarchy comprising one or more of a location level, a unit level, a lease level, a platform level, and a well level.
